(19) United States
(12) Patent Application Publication
(10) Pub. No.: US 2022/0321330 A1
(43) Pub. Date: Oct. 6, 2022

(54) DATA SECURITY FOR NETWORK SLICE MANAGEMENT

(71) Applicant: Nokia Technologies Oy, Espoo (FI)

(72) Inventors: Zhiyuan HU, Shanghai (CN); Yueming YIN, Shanghai (CN); Zhigang LUO, Shanghai (CN)

(21) Appl. No.: 17/634,439

(22) PCT Filed: Aug. 13, 2019
(86) PCT No.: PCT/CN2019/100367

§ 371 Date: Feb. 10, 2022

(51) Int. Cl. H04L 9/08; H04L 9/32

(52) U.S. Cl. CPC H04L 9/0825; H04L 9/0822; H04L 9/3242; H04L 9/3247; H04L 9/3297

(57) ABSTRACT

Embodiments of the present disclosure relate to devices, methods, apparatuses and computer readable storage media of data security for network slice management. The method comprises transmitting at least one entry associated with attributes of data generated by the first device to a second device; in response to a request for accessing the data received from a third device, determining whether the third device has an authority for accessing the data based on the request; and in response to a determination that the third device has the authority for accessing the data, causing the third device to check the integrity of the data based on the attributes of the data obtained from the second device. In this way, the service consumer may detect the data tampering. Moreover, it can be guaranteed that only authorized data user can access the raw performance data, the raw fault data or the configuration data

### FIELD

Embodiments of the present disclosure generally relate to the field of telecommunication and in particular, to devices, methods, apparatuses and computer readable storage media of data security for network slice management.

### BACKGROUND

According to the 3^{rd} Generation Partnership Project (3GPP) and International Telecommunication Union-Telecommunication Standardization Sector (ITU-T) specifications on network slice management and orchestration, network slice management mainly includes configuration management, fault management, performance management, accounting management, security management, and template management (e.g., communication service template, network slice template, and network slice subnet template).

In general, the configuration data, fault data and performance data will be shared with or accessed by some participants e.g., communication service management on behalf of communication service provider, network slice management on behalf of network slice provider and network slice subnet management on behalf of network slice subnet provider.

### SUMMARY

In general, example embodiments of the present disclosure provide a solution of data security for network slice management.

In a first aspect, there is provided a first device. The first device comprises at least one processor; and at least one memory including computer program codes; the at least one memory and the computer program codes are configured to, with the at least one processor, cause the first device at least to transmit at least one entry associated with attributes of data generated by the first device to a second device; in response to a request received from a third device for accessing the data, determine whether the third device has an authority for accessing the data based on the request; and in response to a determination that the third device has the authority for accessing the data, cause the third device to check the integrity of the data based on the attributes of the data obtained from the second device.

In a second aspect, there is provided a second device. The second device comprises at least one processor; and at least one memory including computer program codes; the at least one memory and the computer program codes are configured to, with the at least one processor, cause the second device at least to receive at least one entry associated with attributes of data from the first device; store the attributes of the data in a blockchain; receive from a third device a request for accessing the attributes of the data; and in response to a determination that the third device has the authority for accessing the attributes of the data based on the request, transmit the attributes of the data from the blockchain to the third device.

In a third aspect, there is provided a third device. The third device comprises at least one processor; and at least one memory including computer program codes; the at least one memory and the computer program codes are configured to, with the at least one processor, cause the third device at least to transmit a request to a second device for accessing attributes of data; generate a request for accessing the data at least based on the attributes of the data; transmit the request for accessing the data to the first device; and in response to receiving the data from the first device, check the integrity of the data based on the attributes.

In a fourth aspect, there is provided a method. The method comprises transmitting at least one entry associated with attributes of data generated by the first device to a second device; in response to a request received from a third device for accessing the data, determining whether the third device has an authority for accessing the data based on the request; and in response to a determination that the third device has the authority for accessing the data, causing the third device to check the integrity of the data based on the attributes of the data obtained from the second device.

In a fifth aspect, there is provided a method. The method comprises receiving at least one entry associated with attributes of data from the first device; storing the attributes of the data in a blockchain; receiving from a third device a request for accessing the attributes of the data; and in response to a determination that the third device has the authority for accessing the attributes of the data based on the request, transmitting the attributes of the data from the blockchain to the third device.

In a sixth aspect, there is provided a method. The method comprises transmitting a request to a second device for accessing attributes of data; generating a request for accessing the data at least based on the attributes of the data; transmitting the request for accessing the data to the first device; and in response to receiving the data from the first device, checking the integrity of the data based on the attributes.

In a seventh aspect, there is provided an apparatus comprises means for transmitting at least one entry associated with attributes of data generated by the first device to a second device; means for in response to a request received from a third device for accessing the data, determining whether the third device has an authority for accessing the data based on the request; and means for in response to a determination that the third device has the authority for accessing the data, causing the third device to check the integrity of the data based on the attributes of the data obtained from the second device.

In an eighth aspect, there is provided an apparatus comprises means for receiving at least one entry associated with attributes of data from the first device; means for storing the attributes of the data in a blockchain; means for receiving from a third device a request for accessing the attributes of the data; and means for in response to a determination that the third device has the authority for accessing the attributes of the data based on the request, transmitting the attributes of the data from the blockchain to the third device.

In a ninth aspect, there is provided an apparatus comprises means for transmitting a request to a second device for accessing attributes of data; means for generating a request for accessing the data at least based on the attributes of the data; means for transmitting the request for accessing the data to the first device; and means for in response to receiving the data from the first device, checking the integrity of the data based on the attributes.

In a tenth aspect, there is provided a computer readable medium having a computer program stored thereon which, when executed by at least one processor of a device, causes the device to carry out the method according to the fourth aspect.

In an eleventh aspect, there is provided a computer readable medium having a computer program stored thereon which, when executed by at least one processor of a device, causes the device to carry out the method according to the fifth aspect.

In an twelfth aspect, there is provided a computer readable medium having a computer program stored thereon which, when executed by at least one processor of a device, causes the device to carry out the method according to the sixth aspect.

Other features and advantages of the embodiments of the present disclosure will also be apparent from the following description of specific embodiments when read in conjunction with the accompanying drawings, which illustrate, by way of example, the principles of embodiments of the disclosure.

### BRIEF DESCRIPTION OF THE DRAWINGS

Embodiments of the disclosure are presented in the sense of examples and their advantages are explained in greater detail below, with reference to the accompanying drawings, where

FIG. 1 shows an example system in which example embodiments of the present disclosure may be implemented;

FIG. 2 shows a schematic diagram illustrating a process 200 of data security for network slice management according to example embodiments of the present disclosure;

FIG. 3 shows a schematic diagram illustrating an example structure of one block in the blockchain according to some example embodiments of the present disclosure;

FIG. 4 shows a flowchart of an example method 400 of data security for network slice management according to some example embodiments of the present disclosure;

FIG. 5 shows a flowchart of an example method 500 of data security for network slice management according to some example embodiments of the present disclosure;

FIG. 6 shows a flowchart of an example method 600 of data security for network slice management according to some example embodiments of the present disclosure;

FIG. 7 shows a simplified block diagram of a device that is suitable for implementing example embodiments of the present disclosure; and

FIG. 8 shows a block diagram of an example computer readable medium in accordance with some embodiments of the present disclosure.

Throughout the drawings, the same or similar reference numerals represent the same or similar element.

### DETAILED DESCRIPTION

The subject matter described herein will now be discussed with reference to several example embodiments. It should be understood these embodiments are discussed only for the purpose of enabling those skilled persons in the art to better understand and thus implement the subject matter described herein, rather than suggesting any limitations on the scope of the subject matter.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two functions or acts shown in succession may in fact be executed concurrently or may sometimes be executed in the reverse order, depending upon the functionality/acts involved.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future.

Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system. For the purpose of illustrations, embodiments of the present disclosure will be described with reference to 5G communication system.

The term “network device” used herein includes, but not limited to, a base station (BS), a gateway, a registration management entity, and other suitable device in a communication system. The term “base station” or “BS” represents a node B (NodeB or NB), an evolved NodeB (eNodeB or eNB), a NR (New Radio) NB (also referred to as a gNB), a Remote Radio Unit (RRU), a radio header (RH), a remote radio head (RRH), a relay, a low power node such as a femto, a pico, and so forth.

The term “terminal device” used herein includes, but not limited to, “user equipment (UE)” and other suitable end device capable of communicating with the network device. By way of example, the “terminal device” may refer to a terminal, a Mobile Terminal (MT), a Subscriber Station (SS), a Portable Subscriber Station, a Mobile Station (MS), or an Access Terminal (AT).

The term “circuitry” used herein may refer to one or more or all of the following:

(a) hardware-only circuit implementations (such as implementations in only analog and/or digital circuitry) and

(b) combinations of hardware circuits and software, such as (as applicable):

(i) a combination of analog and/or digital hardware circuit(s) with

software/firmware and

(ii) any portions of hardware processor(s) with software (including digital signal processor(s)), software, and memory(ies) that work together to cause an apparatus, such as a mobile phone or server, to perform various functions) and

(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The communications in the network 100 may conform to any suitable standards including, but not limited to, Long Term Evolution (LTE), LTE-Evolution, LTE-Advanced (LTE-A), Wideband Code Division Multiple Access (WCDMA), Code Division Multiple Access (CDMA) and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

As mentioned above, according to 3GPP and ITU-T specifications on network slice management and orchestration, network slice management mainly includes configuration management, fault management, performance management, accounting management, security management, and template management (e.g., communication service template, network slice template, and network slice subnet template).

In general, the configuration data, fault data and performance data will be shared with or accessed by some participants e.g., communication service management on behalf of communication service provider, network slice management on behalf of network slice provider and network slice subnet management on behalf of network slice subnet provider.

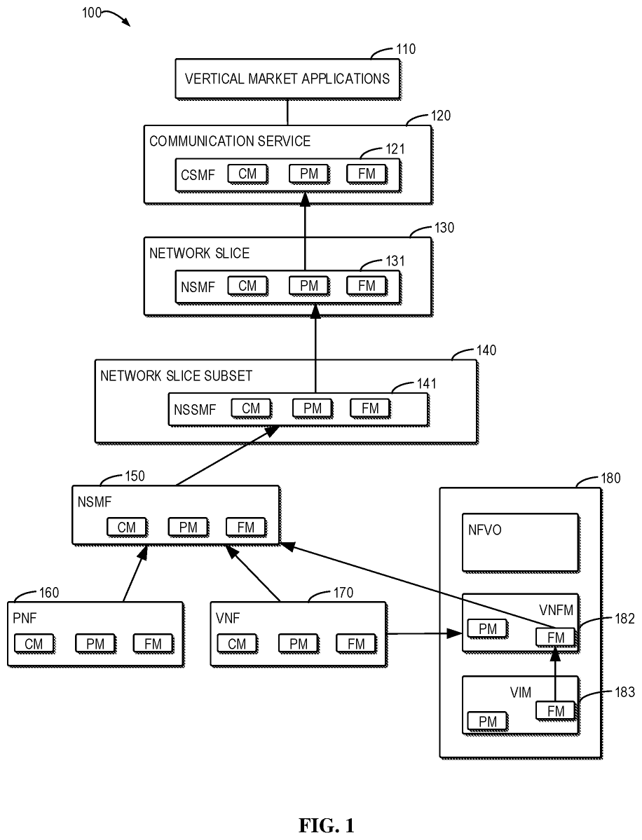

FIG. 1 shows an example system 100 in which example embodiments of the present disclosure may be implemented. The system 100 may comprise vertical market applications 110, which may raise the specific requirement of service. The communication service provider 120 may collect the requirement raised by the vertical market applications and organize at least one network slice provider 130 for provider the required service. The network slice provider 130 may further be associated with the network slice subnet provider 140.

The communication service provider 120 may include a management entity which may referred to as communication service management function (CSMF) 121. The network slice provider 130 may include a management entity which may referred to as network slice management function (NSMF) 131. The network slice subnet provider 140 may include a management entity which may referred to as network slice subnet management function (NSSMF) 141.

Furthermore, the system may also include network function management entities, for example, network function management function (NFMF) 150 and virtual network function management (VNFM) 182. The NFMF 150 may be associated with virtual network function (VNF) 170 and physical network function (PNF) 160. The VNFM 182 may be associated with virtual infrastructure management (VIM) 183.

With reference to FIG. 1, an example data flow may be further described as below. For example, the data is fault management data. The VIM 183 reports virtualized resources alarm data to VNFM 182. The VNFM sends 182 VNF 170 alarm data related to virtualized resources (mapped to VNF instance, correlated or not-correlated) to NFMF 150.

The VNF 170 reports virtualization-specific alarm data to VNFM 182. The VNF 170 instance reports VNF instance application alarm data and virtualization-specific alarm data to NFMF 150. The PNF 160 may report alarm data to NFMF 150.

The NFMF 150 sends the following alarm data to the NSSMF 140: VNF instance application alarm data and virtualization-specific alarm data, VNF alarm data related to virtualized resources, PNF alarm data, and/or correlated VNF instance alarm data. The NFMF 150 may make the alarm correlation using the same VNF instance identifier based on the VNF instance alarm data related to virtualized resource and VNF instance application alarm data. The NFMF 150 may report the correlated VNF instance alarm data to NSSMF 141.

The NSSMF 141 sends alarm data to NSMF 131. The NSSMF 141 may make the alarm correlation using the same network slice subnet instance identifier based on the network subnet instance alarm data related to VNF instance alarm data. The NSSMF 141 may report the correlated network slice subnet alarm data to NSMF 131.

The NSMF 131 then sends alarm data to CSMF 121. The NSMF 131 may make the alarm correlation using the same network slice instance identifier based on the network instance alarm data related to network slice subnet instance alarm data. The NSMF 131 may report the correlated network slice alarm data to CSMF 121.

The data flow of the fault data is similar with the performance data and the data flow of the configuration data is opposite. The description for the data flow for both performance data and the configuration data is omitted.

According to the example described with reference to FIG. 1, a communication service instance may be composed of one or more active network slice instances; and a network slice instance may be composed of one or more active network slice subnet instances; and a network slice subnet instance may be composed of a set of managed run-time network functions. That means, there are some participants (e.g., communication service provider, network slice provider, network slice subnet provider, software vendor, hardware vendor) who collaborate and cooperate to provide customized communication services for a variety of vertical market users.

Firstly, during the operation of vertical market applications, vertical market users may periodically check network slice management data (e.g., performance data, fault data, configuration data) to ensure that the performance and/or availability of communication services conforms to the Service Level Agreements. If the service performance is not so good or the communication service is not available, all the participants may turn to network slice management data to find out what has happened, how it has happened and who is responsible for this issue. The participants at fault may be motivated to tamper network slice management data (by adding, removing, or manipulating a part of network slice management data or the entire network slice management data) in order to hide their fault. Even worse, the participant at fault may try to tamper the network slice management data and fabricate a scenario in which another participant becomes the main reason behind failure and, therefore, responsible for the caused damage. Given that network slice management data is generated and stored in each participant's own data center, there are many tampering possibilities. So, this is a new requirement for all participants to work together and share network management data especially fault data in order to track the participants who are responsible for the issue when the communication service is not available or performance is not so good.

Secondly, according to existing 3GPP & ITU-T specifications on network slice management & orchestration, it's mentioned that only authorized consumer who can play the role of NFMF or NSSMF or NSMF or CSMF to access the corresponding network slice management data (e.g., fault/performance data). However, these specifications do not specify any security countermeasure to solve this issue.

Thirdly, configuration data is sensitive since a skilled attacker may use system configuration data to penetrate network slice system. Moreover, it's very important to verify that configuration data is defined/created by an authentic party and is not modified or eavesdropped during the transportation.

Some solutions were proposed to detect the tamper of the data. However, such solutions may not ensure that network slice management data is tamper-proof. These solutions may require a mediator, known as third-party auditor, which verifies the integrity of the data and sends the integrity report to the users. That means the trust in a third-party or central authority is still be required.

Therefore, the embodiments of the present disclosure proposed a method of data security for network slice management. By means of a blockchain-based management entity, once the data is generated by a data generator, the attribute of data can be recorded/published in a blockchain-based management entity. If the data user intends to check the data, the data user may require the attribute of data from the management entity and require the data from the data generator. The data user may check the integrity of the data based on the attribute of data.

As used herein, the term “management entity” refers to any component, module or node in a network management side, which may be referred to as a Management Function, an Element Manager, a Network Manager or a Domain Manager defined in 3GPP SA5. The management entity may define a managed service Information Object Class (Managed Service IOC) and build the association between the Managed Service IOC and a Network Function (NF) service in the network side. As an option, the term “management entity” may be also referred to a module embedded in the network side which may manage the service of the network.

As used herein, the term “service provider” may be referred to a network operator or a network entity. For example, for communication service provider, network slice provider, network slice subnet provider, and network infrastructure provider, the term “service provider” may be a network operator. For network slice management, NSMF, who acts as an example of network slice management service provider, while CSMF, who acts as an example of network slice management service consumer. In this context, the term “service provider” may be acted by a network entity.

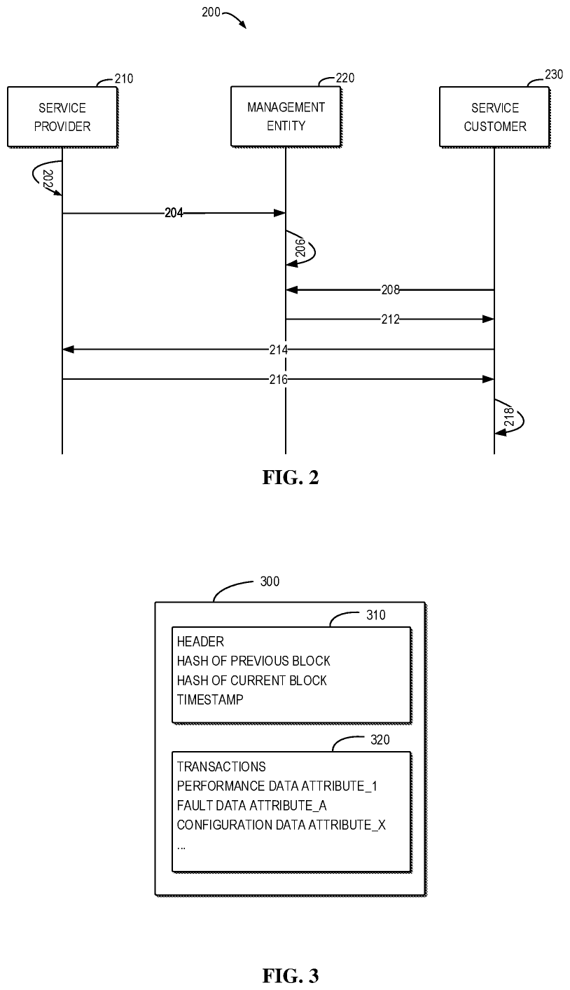

Principle and implementations of the present disclosure will be described in detail below with reference to FIG. 2, which shows a schematic diagram of a process 200 of data security for network slice management. For the purpose of discussion, the process 200 will be described with reference to FIG. 1.

In FIG. 2, the service provider 210 and the service consumer 230 may be referred to multiple functions or entities in FIG. 1, which depends on the type of the data and the corresponding direction of the data flow. For example, if the data is performance data or fault data, the service provider 210 and the service consumer 230 may be the NSMF 131 and CSMF 121, the NSSMF 141 and the NSMF 131 and the NFMF 150 and the NSSMF 141, respectively. If the data is configuration data, the service provider 210 and the service consumer 230 may be the CSMF 121 and the NSMF 131, the NSMF 131 and the NSSMF 141, and NSSMF 141 and the NFMF 150, respectively.

Hereafter the service provider 210 may also be referred to as a first device 210 or a data generator and the service consumer 230 may also be referred to a third device 230 or as a data user. The multiple functions or entities as mentioned above may include corresponding module to generate/operate the data in the multiple types.

The management entity 220, as mentioned above, may be a management node of the network management side. Hereafter the management entity 220 may also be referred to as a second device 220. A logical function “blockchain-based fault/performance/configuration data management” is introduced into the management entity 220. Since the volume of fault/performance data of network slice management is too big to be stored at the ledger/block and the configuration data/parameter is sensitive and will be not stored at the ledger/block publicly, some attributes of fault/performance/configuration data may be collected and stored at the ledger/block, while the raw fault/performance/configuration data may be collected and stored at other datacenters. If raw fault/performance/configuration data is modified intentionally or unintentionally, the modification will be detected with the corresponding attributes stored at the ledger/block.

This logical function “blockchain-based fault/performance/configuration data management” may be deployed in the server side. It may be deployed in the same host with communication service management or network slice management. This logical function may manage the registration of fault/performance/configuration data generators and data users. The unique identifier of data generator or data user includes his/her public key and other parameters. The data generator and data user should keep the corresponding private key by themselves.

This logical function may store the ledgers/blocks which include the attributes of fault/performance/configuration data. This logical function “blockchain-based fault/performance/configuration data management” has the capability of a full node with keeping a full-copy of the blockchain. Furthermore, this logical function “blockchain-based PM/FM/CM data management” may act as a blockchain node and have the capability of creating new blocks/ledgers.

Moreover, this logical function may authorize the data user to access the requested fault/performance/configuration data. This logical function has the capability of authenticating data user who requests access fault/performance/configuration data. This logical function has the capability of checking if data user has the right to access the requested fault/performance/configuration data. This logical function also has the capability of generating “access token” with which data user can access the requested fault/performance/configuration data.

Correspondingly, some logical functions are introduced into the the service provider 210 and the service consumer 230. For example, the logical function “data attributes posted to the chain” and the logical function “data access control” may be introduced to the service provider 210.

The logical function “data attributes posted to the chain” may collect the attributes of performance/fault/configuration data, and then send the collected attributes to the blockchain nodes which are capable to generate a new block/ledger. The blockchain nodes aggregate the attributes, create a new block/ledger then publish the new block/ledger to the chain. How to build a blockchain node is out of scope of this document.

The logical function “data access control” may validate the “access token” which is generated by the logical function “blockchain-based fault/performance/configuration data management”. If validating successfully, the requested data will be sent to the data user.

For example, the logical function “data integrity check” may be introduced into the service consumer 230, which may check if the fault/performance/configuration data is tampered or not with the value of data_hash.

Furthermore, to ensure the security of the configuration data in the transfer, the logical function “data encryption” may be introduced into service provider 210 and the logical function “data decryption” may be introduced into the service consumer 230. The logical function “data encryption” may encrypt configuration data before the data is sent to the data user. The logical function “data decryption” may decrypt the configuration data in ciphertext after it is received from the data generator.

Hereafter, an example of process 200 for data security will be described in detail a below. As shown in FIG. 2, the service provider 210 may generate 202 data associated with the service provided by the service provider 210 while generating an entry of the attributes of the data. The entry of the attributes of the data may have a predefined format. For example, an example for the entry of the attributes of fault/performance data may be represent as below.

TABLE 1
attributes of fault/performance data
generated by NSMF 131 and used by CSMF 121

| | | | | | | | |
|---|---|---|---|---|---|---|---|
| data_ | data_ | data_ | data-_ | timestamp | data_storage_ | data_ | sig- |
| index | type | generator | user | | location | hash | nature |

The attributes in Table-1 are defined as following:

data_index: an identifier to indicate the index of fault/performance/configuration data attributes. The fault/performance/configuration data is used for fault/performance/configuration management in CSMF (communication service management function).
data_type: a flag to indicate data types of the fault/performance/configuration data which is used for performance management, fault management (e.g., alarm data) and configuration management.
data_generator: an identifier which includes the public key of network slice provider and the identifier of the corresponding/serving network slice instance. That means fault/performance data is generated by and/or collected from the corresponding/serving network slice instance. This field data_generator may be divided into two subfields i.e., the public key of network slice provider and the identifier of the corresponding/serving network slice instance.
data_user: an identifier which includes the public key of communication service provider and the identifier of the corresponding/serving communication service instance. This field data_user may be divided into two subfields i.e., the public key of communication service provider and the identifier of the corresponding/serving communication service instance. For configuration management, above two fields data_generator and data_user swap roles. That means, the field data_generator of configuration data is an identifier which includes the public key of communication service provider and the identifier of the corresponding/serving communication service instance; while the file data_user of configuration data is an identifier which includes the public key of network slice provider and the identifier of the corresponding/serving network slice instance. Moreover, data_user may be a group of network slice instances. That means, the configuration data can apply to one or more collaborated network slice instances.
timestamp: the time of the attributes of fault/performance/configuration data collected or generated.
data_storage_location: the location of fault/performance/configuration data storage, which may be a file, or a table of database, or an entry of a table.
data_hash: a hash value of the fault/performance/configuration data and its corresponding attributes.
signature: the signature is generated with the private key of the attribute generator. That means, for fault/performance data, the signature is generated with the private key of network slice provider. For configuration data, the signature is generated with the private key of communication service provider.

Furthermore, another example for the entry of the attributes of fault/performance data may be represent as below.

TABLE 2
attributes of fault/performance data
generated by NSSMF 141 and used by NSMF 131

| | | | | | | | |
|---|---|---|---|---|---|---|---|
| data_ | data_ | data_ | data-_ | timestamp | data_storage_ | data_ | sig- |
| index | type | generator | user | | location | hash | nature |

The attributes in Table-2 are defined as following:

data_index: an identifier to indicate the index of fault/performance/configuration data attributes. The fault/performance/configuration data is used for fault/performance/configuration management in NSMF (network slice management function).
data_type: a flag to indicate data types of the fault/performance/configuration data which is used for performance management, fault management (e.g., alarm data) and configuration management.
data_generator: an identifier which includes the public key of network slice subnet provider and the identifier of the corresponding/serving network slice subnet instance. That means fault/performance data is generated by and/or collected from the corresponding/serving network slice subnet instance. This field data_generator may be divided into two subfields i.e., the public key of network slice subnet provider and the identifier of the corresponding/serving network slice subnet instance.
data_user: an identifier which includes the public key of network slice provider and the identifier of the corresponding/serving network slice instance. This field data_user may be divided into two subfields i.e., the public key of network slice provider and the identifier of the corresponding/serving network slice instance. For configuration management, above two fields data_generator and data_user swap roles. That means, the field data_generator of configuration data is an identifier which includes the public key of network slice provider and the identifier of the corresponding/serving network slice instance; while the file data_user of configuration data is an identifier which includes the public key of network slice subnet provider and the identifier of the corresponding/serving network slice subnet instance. Moreover, data_user may be a group of network slice subnet instances. That means, the configuration data can apply to one or more collaborated network slice subnet instances.
timestamp: the time of the attributes of fault/performance/configuration data collected.
data_storage_location: the location of fault/performance/configuration data storage, which may be a file, or a table of database, or an entry of a table.
data_hash: a hash value of the fault/performance/configuration data and its corresponding attributes.
signature: the signature is generated with the private key of the attribute generator. That means, for fault/performance data, the signature is generated with the private key of network slice subnet provider. For configuration data, the signature is generated with the private key of network slice provider.

It should be understood that the attributes of the fault/performance/configuration data operated&managed in NSSMF/NFMF can also be defined in the same way as the attributes defined in Table-1 and in Table-2, which will not be shown in this description.

Referring back to FIG. 2, the logical function “data attributes posted to chain” of the service provider 210 publishes 204 at least one entry of the attributes of data to the management entity 220. The service provider 210 may transmit the at least one entry periodically or transmit the predetermined number of entries to the management entity 220.

The logical function “blockchain-based PM/FM/CM data management” of the management entity 220 may collect the attributes of data from the at least one entry and store 206 the attributes in the blockchain. For example, the management entity 220 receives entry 1 and entry 2, which represent the attributes of data 1 and the attributes of data 2, respectively. The management entity 220 may aggregate the attributes of data 1 and the attributes of data 2 and create a block to store the attributes of data 1 and the attributes of data 2. The management entity 220 may further publish the new block to the chain.

FIG. 3 shows a schematic diagram illustrating an example structure of one block in the blockchain according to some example embodiments of the present disclosure. The block 300 may include header 310 and the transaction 320. The header 310 may indicate some attributes associated with the block 300, such as hash of the previous block and hash of current block. The transaction 320 may store the attributes of data, such as the attributes of data 1 and the attributes of data 2, as mentioned above.

Referring back to FIG. 2, the service consumer 230 may be triggered to check the data provided by the service provider 210, if the service is getting worse or the operation of the service fails. The service consumer 230 may transmit 208 a request to the management entity 220 for accessing the attributes of data, i.e. the “attributes access request” message.

The request for accessing the data may comprise the public key of the service consumer 230 and the public key of the service provider 210. Furthermore, the request for accessing the data may also comprise the type of the data which the service consumer 230 intends to check and the time of the generation or collection of the data.

The logical function “blockchain-based PM/FM/CM data management” of the management entity 220 may authenticate the service consumer 230 with its public key, then checks if the data_user list includes the requested the service consumer 230. If the requested service consumer 230 is authenticated successfully and is in the data_user list, the logical function “blockchain-based PM/FM/CM data management” of the management entity 220 may generate an “access_token”. The logical function “blockchain-based PM/FM/CM data management” of the management entity 220 then transmit 212 the “attributes access response” message to the service consumer 230. This response message may include data storage location “data_storage_location”, hash value of raw data “data_hash” and the access token “access_token”.

After receiving the “attributes access response” message from the management entity 220, the service consumer 230 transmits 214 a request for accessing the data, i.e. the “data access request” message to the service provider 210 in order to access the data. This request message may include the public key of the service consumer 230, data storage location “data_storage_location” at the service provider 210 and the access token “access_token”.

After receiving the “data access request” message from the service consumer 230, the service provider 210 may validate the “access_token”. If the “access_token” is valid, the logical function “data access control” of the service provider 210 may cause that the service provider 210 sends the “data access response” message back to the service consumer 230. Thus, the service provider 210 transmit 216 this response message includes the requested data. Herein the data may be referred to the performance data or fault data. The case for requesting the configuration data will be described later.

After receiving the requested raw performance data or raw fault data, the logical function “data integrity check” of the service consumer 230 may check 218 the integrity of data. The service consumer 230 may calculate the hash value of the received raw data and compare the calculated hash value with the hash value “data_hash” received from the management entity 220. If these two hash values are equal, the raw performance data or fault data is not tampered.

As mention above, to ensure the security of the configuration data in the transfer, the logical function “data encryption” may be introduced into service provider 210 and the logical function “data decryption” may be introduced into the service consumer 230. In some example embodiments, service provider 210 notifies service consumer 230 to get the new and/or updated configuration data which will be set/configured into the network slice instance. In this way, the network slice instance can provide communication services according to the requirements from communication service provider. This notification message includes the location of the attributes of configuration data in the chain.

In a case of requesting the configuration data, if the service provider 210 determine that the “access_token” is valid, the service provider 210 sends the “data access response” message back to the service consumer 230. This response message includes encrypted raw configuration data and encrypted session key. The raw configuration data is encrypted by the logical function “data encryption” of the service provider 210 with a session key. This session key is generated by the logical function “data encryption” and encrypted by the logical function “data encryption” with the public key of the service consumer 230.

After receiving the “data access response” message, the logical function “data decryption” of the service consumer 230 gets the session_key in plaintext with the public key of the service consumer 230, then gets raw configuration data in plaintext with the sessionkey. The logical function “data integrity check” of the service consumer 230 may calculate the hash value of the obtained raw configuration data and compare the calculated hash value with the hash value “data_hash”. If these two hash values are equal, the raw configuration is not tampered.

In this way, the service consumer may detect the data tampering. Moreover, it can be guaranteed that only authorized data user can access the raw performance data, the raw fault data or the configuration data.

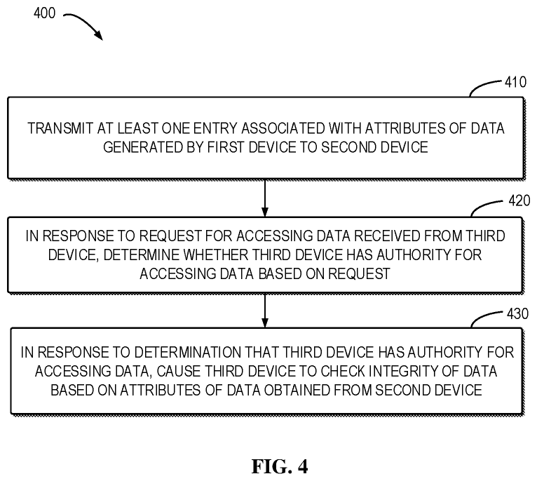

FIG. 4 shows a flowchart of an example method 400 of data security for network slice management according to some example embodiments of the present disclosure. The method 400 can be implemented at the service provider 210 as shown in FIG. 2. For the purpose of discussion, the method 400 will be described with reference to FIG. 2.

As shown in FIG. 4, at 410, the service provider 210 transmits at least one entry associated with attributes of data generated by the service provider 210 to the service consumer 230.

In some example embodiments, the attributes comprise at least one of the following an index of the data, a type of the data, an identifier of the service provider 210, an identifier of the service consumer 230, a timestamp of the generation of the entry, a storage location of the data, an original hash value of the data, or a signature of the service provider 210.

At 420, if the request for accessing the data received from the service consumer 230, the service provider 210 determines whether the service consumer 230 has an authority for accessing the data based on the request.

In some example embodiments, the request for accessing the data comprise at least one of the following a public key of the service consumer 230, a storage location of the data at the service provider 210, and an access token for accessing the data of the service provider 210.

In some example embodiments, the service provider 210 may obtain an access token for accessing the data from the request. The service provider 210 determines the validity of the access token. Based on the determined validity of the access token, the service provider 210 may determine that the third device has an authority for accessing the data.

At 430, if the service provider 210 determines that the third device has the authority for accessing the data, cause the service consumer 230 to check the integrity of the data based on the attributes of the data obtained from the management entity 220.

In some example embodiments, if the data is associated with a configuration of a network slice provided by the service provider 210, the service provider 210 may obtain a public key of the service consumer 230 from the request, encrypt a session key for the data access with the public key and encrypt the data with the session key. The service provider 210 may further transmit the encrypted data to the service consumer 230.

In some example embodiments, if the data is associated with one of performance and fault of a network slice, the service provider 210 may transmit the data to the service consumer 230.

In some example embodiments, the service provider 210 may generate the at least one entry associated with attributes of data while generating the data.

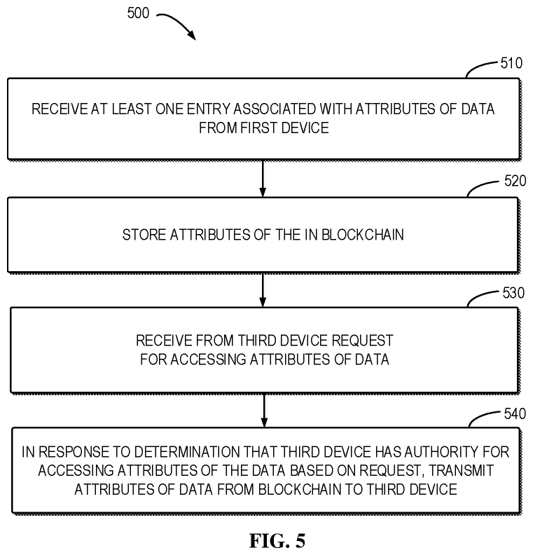

FIG. 5 shows a flowchart of an example method 500 of data security for network slice management according to some example embodiments of the present disclosure. The method 500 can be implemented at the management entity 220 as shown in FIG. 2. For the purpose of discussion, the method 500 will be described with reference to FIG. 2.

As shown in FIG. 5, at 510, the management entity 220 receives at least one entry associated with attributes of data from the service provider 210.

In some example embodiments, the attributes comprise at least one of the following an index of the data, a type of the data, an identifier of the service provider 210, an identifier of the service consumer 230, a timestamp of the generation of the entry, a storage location of the data, an original hash value of the data, or a signature of the service provider 210.

At 520, the management entity 220 stores the attributes of the data in a blockchain.

In some example embodiments, the management entity 220 may extract a first plurality of attributes of the data from the first entry and a second plurality of attributes of the data from the second entry; and aggregate the first plurality of attributes of the data and the second plurality of attributes of the data into at least one block in the blockchain.

At 530, the management entity 220 receives from the service consumer 230 a request for accessing the attributes of the data.

In some example embodiments, the management entity 220 may receive at least one of the following: a public key of the service consumer 230, a public key of the service provider 210, a type of the data, and time for generating of the attributes of the data.

At 540, if the service consumer 230 has the authority for accessing the attributes of the data based on the request, the management entity 220 transmits the attributes of the data from the blockchain to the service consumer 230.

In some example embodiments, the management entity 220 may obtain a public key of the service consumer 230 from the request and determine whether the public key of the service consumer 230 is included in an authorized access list at the management entity 220. The management entity 220 may further determine the authority for accessing the attributes of the data for the service consumer 230, if the public key of the service consumer 230 is included in the authorized access list.

In some example embodiments, the management entity 220 may transmit at least one of the following: an access token for accessing the data of the service provider 210, a storage location of the data at the service provider 210, and an original hash value of the data.

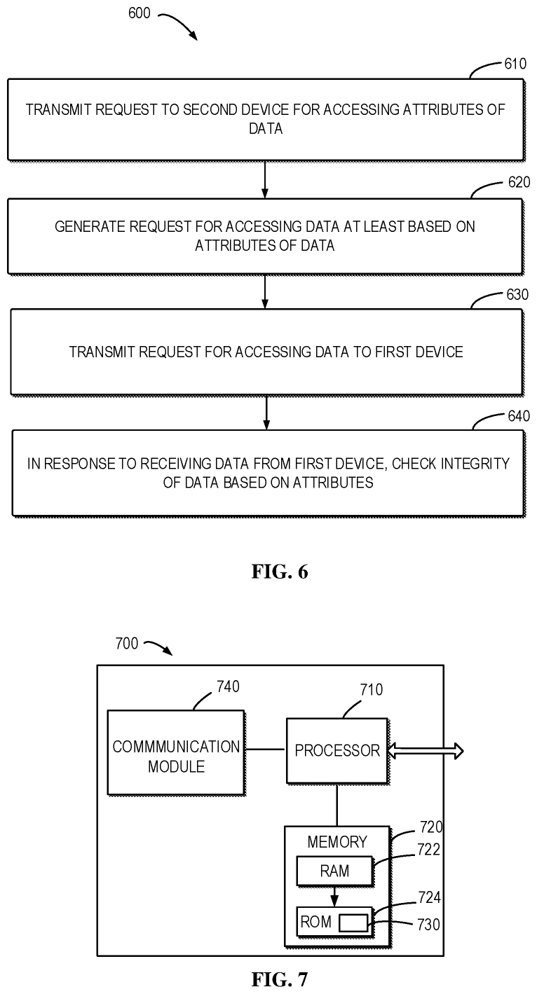

FIG. 6 shows a flowchart of an example method 600 of data security for network slice management according to some example embodiments of the present disclosure. The method 600 can be implemented at the service consumer 230 as shown in FIG. 2. For the purpose of discussion, the method 600 will be described with reference to FIG. 2.

As shown in FIG. 6, at 610, the service consumer 230 transmits a request to a management entity 220 for accessing attributes of data.

In some example embodiments, the service consumer 230 may transmit at least one of the following: a public key of the service consumer 230, a public key of the service provider 210, a type of the data, and time for generating of the data.

In some example embodiments, the service consumer 230 may receive at least one of the following: an access token for accessing the data of the service provider 210, a storage location of the data at the service provider 210, and an original hash value of the data.

At 620, the service consumer 230 generates a request for accessing the data at least based on the attributes of the data.

At 630, the service consumer 230 transmits the request for accessing the data to the service provider 210.

In some example embodiments, the service consumer 230 may transmit at least one of the following: a public key of the service consumer 230, a storage location of the data at the service provider 210, and an access token for accessing the data of the service provider 210.

At 640, if the service consumer 230 receives the data from the service provider 210, the service consumer 230 checks the integrity of the data based on the attributes.

In some example embodiments, the service consumer 230 may determine a calculated hash value of the data, obtain the original hash value of the data from the attributes; and compare the calculated hash value of the date with an original hash value of the data. The service consumer 230 may determine the data is unmodified if the calculated hash value equals to the original hash value.

In some example embodiments, an apparatus capable of performing the method 400 (for example, implemented at the service provider 210) may comprise means for performing the respective steps of the method 400. The means may be implemented in any suitable form. For example, the means may be implemented in a circuitry or software module.

In some example embodiments, the apparatus comprises means for transmitting at least one entry associated with attributes of data generated by the first device to a second device; means for in response to a request for accessing the data received from a third device, determining whether the third device has an authority for accessing the data based on the request; and means for in response to a determination that the third device has the authority for accessing the data, causing the third device to check the integrity of the data based on the attributes of the data obtained from the second device.

In some example embodiments, an apparatus capable of performing the method 500 (for example, implemented at the management entity 220) may comprise means for performing the respective steps of the method 500. The means may be implemented in any suitable form. For example, the means may be implemented in a circuitry or software module.

In some example embodiments, the apparatus comprises means for receiving at least one entry associated with attributes of data from the first device; means for storing the attributes of the data in a blockchain; means for receiving from a third device a request for accessing the attributes of the data; and means for in response to a determination that the third device has the authority for accessing the attributes of the data based on the request, transmitting the attributes of the data from the blockchain to the third device.

In some example embodiments, an apparatus capable of performing the method 600 (for example, implemented at the service consumer 230) may comprise means for performing the respective steps of the method 600. The means may be implemented in any suitable form. For example, the means may be implemented in a circuitry or software module.

In some example embodiments, the apparatus comprises means for transmitting a request to a second device for accessing attributes of data; means for generating a request for accessing the data at least based on the received attributes of the data; means for transmitting the request for accessing the data to the first device; and means for in response to receiving the data from the first device, checking the integrity of the data based on the attributes.

FIG. 7 is a simplified block diagram of a device 700 that is suitable for implementing embodiments of the present disclosure. The device 700 may be provided to implement the communication device, for example the service provider 210, management entity 220 and the service consumer 230 as shown in FIG. 2. As shown, the device 700 includes one or more processors 710, one or more memories 740 coupled to the processor 710, and one or more transmitters and/or receivers (TX/RX) 740 coupled to the processor 710.

The TX/RX 740 is for bidirectional communications. The TX/RX 740 has at least one antenna to facilitate communication. The communication interface may represent any interface that is necessary for communication with other network elements.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), and other magnetic storage and/or optical storage. Examples of the volatile memories include, but are not limited to, a random-access memory (RAM) 722 and other volatile memories that will not last in the power-down duration.

A computer program 730 includes computer executable instructions that are executed by the associated processor 710. The program 730 may be stored in the ROM 720. The processor 710 may perform any suitable actions and processing by loading the program 730 into the RAM 720.

The embodiments of the present disclosure may be implemented by means of the program 730 so that the device 700 may perform any process of the disclosure as discussed with reference to FIGS. 2 to 6. The embodiments of the present disclosure may also be implemented by hardware or by a combination of software and hardware.

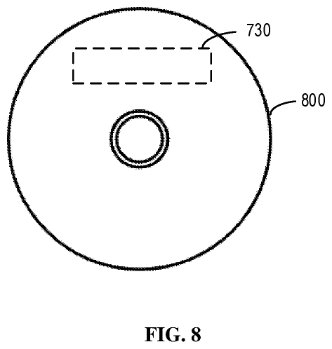

In some embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. The computer readable medium may include any types of tangible non-volatile storage, such as ROM, EPROM, a flash memory, a hard disk, CD, DVD, and the like. FIG. 8 shows an example of the computer readable medium 800 in form of CD or DVD. The computer readable medium has the program 730 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods 400-600 as described above with reference to FIGS. 2-6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-48. (canceled)

49. A first device comprising:
at least one processor; and
at least one memory including computer program codes;
the at least one memory and the computer program codes are configured to, with the at least one processor, cause the first device at least to:
transmit at least one entry associated with attributes of data generated by the first device to a second device;
in response to a request received from a third device for accessing the data, determine whether the third device has an authority for accessing the data based on the request; and
in response to a determination that the third device has the authority for accessing the data, cause the third device to check the integrity of the data based on the attributes of the data obtained from the second device.

50. The first device of claim 49, wherein the attributes comprise at least one of the following:
an index of the data,
a type of the data,
an identifier of the first device,
an identifier of the third device,
a timestamp of the generation of the entry,
a storage location of the data,
an original hash value of the data, or
a signature of the first device.

51. The first device of claim 49, wherein the request for accessing the data comprise at least one of the following:
a public key of the third device,
a storage location of the data at the first device, and
an access token for accessing the data of the first device.

52. The first device of claim 49, wherein the first device is caused to determine whether the third device has an authority for accessing the data further comprises:
obtain an access token for accessing the data from the request; and
in response to determination of a validity of the access token, determine that the third device has an authority for accessing the data.

53. The first device of claim 49, wherein the data is associated with a configuration of a service provided by the first device, wherein the first device is caused to cause the third device to check the integrity of the data further comprises:
obtain a public key of the third device from the request;
encrypt a session key for the data access with the public key;
encrypt the data with the session key; and
transmit the encrypted data to the third device.

54. The first device of claim 49, wherein the data is associated with one of performance and fault of a service provided by the first device, wherein the first device is caused to cause the third device to check the integrity of the data further comprises:
transmit the data to the third device.

55. The first device of claim 49, wherein the first device is further caused to:
generate the at least one entry associated with attributes of data while generating the data.

56. The first device of claim 49, wherein the first device is a service provider, the second device is a management entity and the third device is a service consumer.

57. A second device comprising:
at least one processor; and
at least one memory including computer program codes;
the at least one memory and the computer program codes are configured to, with the at least one processor, cause the second device at least to:
receive at least one entry associated with attributes of data from a first device;
store the attributes of the data in a blockchain;
receive from a third device a request for accessing the attributes of the data; and
in response to a determination that the third device has the authority for accessing the attributes of the data based on the request, transmit the attributes of the data from the blockchain to the third device.

58. The second device of claim 57, wherein the attributes comprise at least one of the following:
an index of the data,
a type of the data,
an identifier of the first device,
an identifier of the third device,
a timestamp of the generation of the entry,
a storage location of the data,
an original hash value of the data; or
a signature of the first device.

59. The second device of claim 57, wherein the at least one entry comprises a first entry and a second entry, and wherein the second device is caused to store the attributes of the data in the blockchain further comprises:
extract a first plurality of attributes of the data from the first entry and a second plurality of attributes of the data from the second entry; and
aggregate the first plurality of attributes of the data and the second plurality of attributes of the data into at least one block in the blockchain.

60. The second device of claim 57, wherein the second device is caused to receive a request for accessing the attributes of the data by receiving at least one of the following:
a public key of the third device,
a public key of the first device,
a type of the data, and
time for generating of the data.

61. The second device of claim 57, wherein the second device is further caused to:
obtain a public key of the third device from the request;
determine whether the public key of the third device is included in an authorized access list at the second device; and
in response to the public key of the third device is included in the authorized access list, determine the authority for accessing the attributes of the data for the third device.

62. The second device of claim 57, wherein the second device is caused to transmit the attributes of the data by transmit at least one of the following:
an access token for accessing the data of the first device,
a storage location of the data at the first device, and
an original hash value of the data.

63. The second device of claim 57, wherein the first device is a service provider, the second device is a management entity and the third device is a service consumer.

64. A third device comprising:
at least one processor; and
at least one memory including computer program codes;
the at least one memory and the computer program codes are configured to, with the at least one processor, cause the third device at least to:
transmit a request to a second device for accessing attributes of data;
generate a request for accessing the data at least based on the attributes of the data;
transmit the request for accessing the data to a first device; and
in response to receiving the data from the first device, check the integrity of the data based on the attributes.

65. The third device of claim 64, wherein the third device is caused to transmit the request for accessing the attributes of the data by transmitting at least one of the following:
a public key of the third device,
a public key of the first device,
a type of the data, and
time for generating of the data.

66. The third device of claim 64, wherein the third device is further caused to receiving at least one of the following from the second device:
an access token for accessing the data of the first device,
a storage location of the data at the first device, and
an original hash value of the data.

67. The third device of claim 64, wherein the third device is caused to transmit the request for accessing the data by transmitting at least one of the following:
a public key of the third device,
a storage location of the data at the first device, and
an access token for accessing the data of the first device.

68. The third device of claim 64, wherein the third device is caused to check the integrity of the data further comprises:
determine a calculated hash value of the data;
obtain the original hash value of the data from the attributes;
compare the calculated hash value of the date with an original hash value of the data; and
in response to determine that the calculated hash value equals to the original hash value, determine the data is unmodified.
